(19) United States
(12) Patent Application Publication
(10) Pub. No.: US 2009/0134993 A1
(43) Pub. Date: May 28, 2009

(54) Thermostat With Audible Interconnect To Threat Detectors

(75) Inventor: Nicholas Ashworth, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/946,578

(22) Filed: Nov. 28, 2007

(51) Int. Cl. H04Q 1/30; G08B 23/00

(52) U.S. Cl. 340/501; 340/531

(57) ABSTRACT

A thermostat for controlling a heating, ventilating and air conditioning (HVAC) system based an audible warning signal is provided. The thermostat comprises a microphone and an electronic circuit. The microphone senses the audible warning signal and generates an electrical signal corresponding to the audible warning signal. The electronic circuit is operably coupled to the microphone. The electronic circuit instructs the HVAC system according to the electrical signal. As such, the HVAC system is controlled based upon the audible warning signal.

### FIELD OF THE INVENTION

This invention generally relates to heating, ventilation, and air conditioning systems and, more particularly, to thermostats employed in those systems.

### BACKGROUND OF THE INVENTION

Most existing structures (e.g., residential dwellings, office buildings, etc.) are equipped with a thermostat for controlling a heating, ventilating and air conditioning (HVAC) system. The thermostat instructs the HVAC system such that the temperature and humidity within the structures is well regulated. Traditionally, the thermostat was a fairly simple electromechanical device. However, advances in control electronics have allowed the development of new, digital thermostats that may be programmed by a user to control the heating and cooling equipment in a much more energy efficient manner than the older electromechanical devices. These modern digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week. For example, such a digital thermostat may provide for one programmed operation during the week and a different programmed operation on the weekend, to accommodate the different usage patterns of the occupants of that particular dwelling or structure.

The structures are also often provided with hazardous condition detectors such as smoke alarms and/or carbon monoxide (CO) detectors. Upon an occurrence of a hazardous condition within the structure (e.g., fire and smoke, carbon monoxide build up, etc.), one or more of the hazardous condition detectors produces an audible and/or visual warning signal. The warning signal is intended to alert occupants of the structure to the hazardous condition and permit those occupants to evacuate before the hazardous condition further escalates.

For new construction, modern building codes often require that several of the hazardous condition detectors be employed within the structure. In fact, the building codes typically require that at least one of the hazardous condition detectors be installed on each floor, in each sleeping quarters, and the like. Because these areas are frequently spread throughout the structure, the hazardous condition detectors are often remotely placed from one another. As a result, it has become more commonplace (and a code requirement in some regions) to provide some type of interconnection between the various hazardous condition detectors. In other words, the hazardous condition detectors must be able to communicate with each other. Consequently, if one of the hazardous condition detectors sense a dangerous condition, all of the detectors can generate a collective warning signal.

Unfortunately, while the group of hazardous condition detectors variously dispersed within the structure are typically in communication with each other, they are not in communication with the thermostat. As a result, the hazardous condition detectors are not tied into the HVAC system. Should a hazardous condition such as, for example, a fire occur within the structure, the HVAC system may very well continue to operate and make the hazardous condition much worse by spreading smoke throughout the structure, continuing to feed the fire, etc.

There exists, therefore, a need in the art for a thermostat that is able to sense a warning signal generated by a hazardous condition sensor upon the occurrence of a hazardous condition and, based on the sensed warning signal, instruct the HVAC system accordingly. The invention provides such a thermostat. These and other advantages of the invention, as well as additional inventive features, will be apparent from the description of the invention provided herein.

### BRIEF SUMMARY OF THE INVENTION

Embodiments of the invention provide a thermostat able to sense an audible warning signal generated by one or more hazardous condition sensors upon the occurrence of a hazardous condition and, based on the sensed warning signal, instruct the HVAC accordingly.

In one embodiment of a thermostat constructed in accordance with the teachings of the present invention, a thermostat for controlling a heating, ventilating and air conditioning (HVAC) system based an audible warning signal is provided. The thermostat includes a microphone capable of sensing the audible warning signal. The microphone generates an electrical signal corresponding to the audible warning signal. An electronic circuit is operably coupled to the microphone. This electronic circuit instructs the HVAC system according to the electrical signal such that the HVAC system is controlled based upon the audible warning signal.

In one embodiment, the thermostat determines what type of hazardous condition has been detected by the audible pattern. Based on this determination, the thermostat then controls the HVAC system to mitigate or at least not exacerbate the hazardous condition. If the audible alarm is signifying the presence of CO, the thermostat turns off or does not turn on the furnace. Preferably, the thermostat also turns on the HVAC fan or blower to circulate fresh air or dissipate the CO concentration. In locations that include a fresh air intake, the thermostat operates to bring in such fresh air. If the audible alarm is signifying the presence of smoke, the thermostat turns off the HVAC system blower and any fresh air intake.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic view of an exemplary embodiment of a thermostat constructed in accordance with the teachings of the present invention and mounted within a structure having hazardous condition detectors; and

FIG. 2 is a front view of the thermostat of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

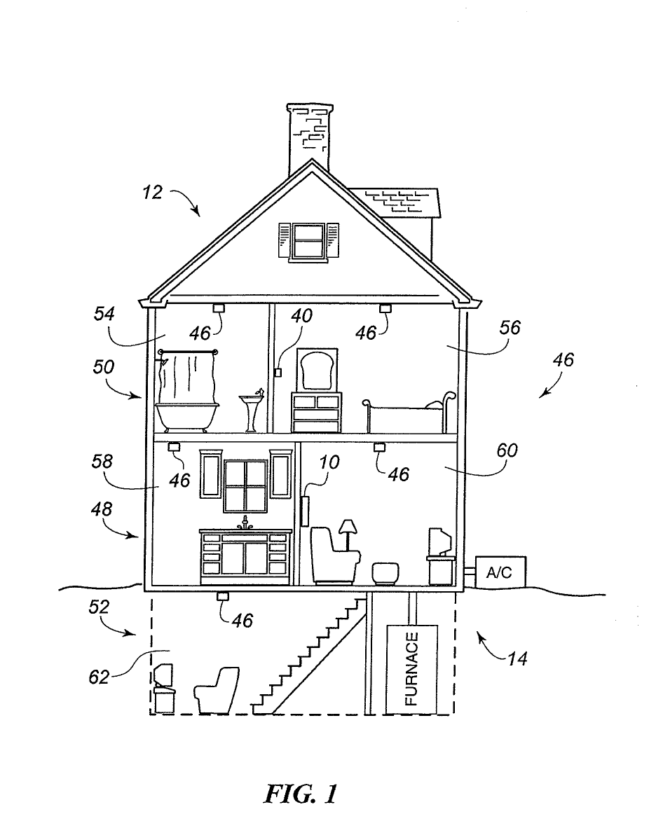

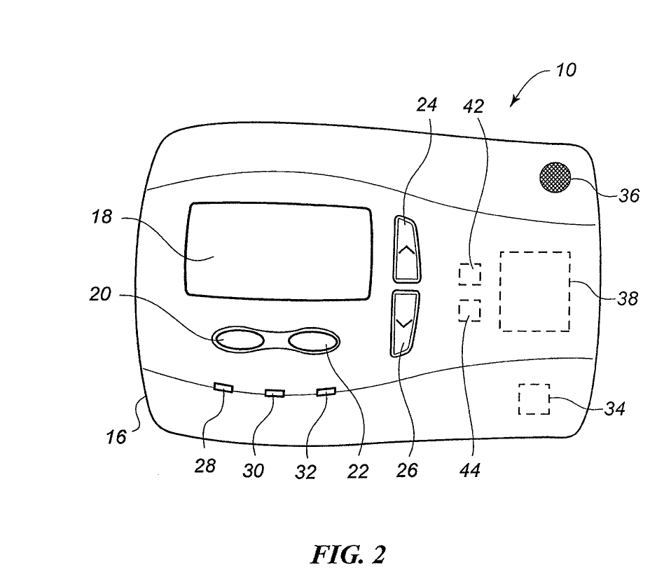

Referring to FIG. 1, a thermostat 10 is illustrated mounted within a structure 12. Although depicted as a residential dwelling in FIG. 1, the structure 12 can also be a commercial building or other type of construction typically serviced by a HVAC system 14. The thermostat 10 is generally able to control and/or instruct a heating, ventilating and air conditioning (HVAC) system 14. As shown in more detail in FIG. 2, one embodiment of the thermostat 10 comprises a housing 16, a display 18, soft keys 20, 22, adjustment keys 24, 26, operating mode visual indicators 28, 30, 32, an internal temperature sensor 34, a microphone 36, and an electronic circuit 38.

The housing 16 is formed from one of a variety of suitable materials such as, for example, plastic. The housing 16 is used for mounting external components (e.g., the display 18, the soft keys 20, 22, the adjustment keys 24, 26, the operating mode visual indicators 28, 30, 32, etc.) and protecting internal components (e.g., the internal temperature sensor 34, the microphone 36, the electronic circuit 38, etc.). The housing 16 is preferably available in a variety of different shapes and/or colors to suitably match the décor or color scheme within the structure 12.

The display 18 displays programming, system, and ambient information regarding the operation of the thermostat 10, the HVAC system 14, and the like. For example, the display 18 can illustrate numbers, text, icons, and the like. These displayed items can be static or, if the thermostat 10 is more advanced, dynamic in nature. The display 18 may take various forms well known in the art. In a preferred embodiment, the display is a dot matrix liquid crystal display (an LCD display).

Using the display 18, the consumer may activate various programming and control functions via the pair of soft keys 20, 22. The functionality executed by these soft keys 20, 22 varies depending upon the program state the thermostat 10 is in at the time one of the soft keys 20, 22 is depressed. The particular functionality that will be instituted upon selection of one of the soft keys 20, 22 is displayed in a portion of the display 18 proximate the key 20, 22 which will institute that function. That is, the function that will be instituted upon selection of soft key 20 will be located generally in the lower left hand portion of the display 18 while the functionality that will be instituted by selection of soft key 22 will be located generally in the lower right hand portion of user display 18. These functional indicators may change depending on the program state and mode in which the thermostat is currently operating.

In addition to the soft keys 20, 22, this embodiment of the thermostat 10 also includes adjustment keys 24, 26. These adjustment keys 24, 26 may serve to adjust a currently selected parameter up or down, such as in the case of setting the control temperature at which the thermostat will maintain the ambient environment. Additionally, these keys 24, 26 may scroll through the available data for a selected parameter, such as scrolling through alphanumeric data that may be selected for a given parameter. These keys 24, 26 may also function as soft keys depending on the programmatic state in which the thermostat is operating. When this functionality is provided, the function that will be instituted by selection of key 24 will be provided generally in the upper right hand corner of display 18, while the functionality that will be instituted by selection of key 26 will be displayed generally in the lower right hand corner of the display 18. In addition to the above, other use input means, such as an alphanumeric keypad, user rotatable knob, a touch screen, and the like, may be utilized instead of the buttons 20, 22, 24 and 26 illustrated in the embodiment of FIG. 2.

The indicators 28, 30, 32 provide a visual indication of the current operating mode of the thermostat 10 and/or the HVAC system 14. In the embodiment illustrated in FIG. 2, indicator 28 illuminates while the thermostat 10 is operating in the cooling mode. In the cooling mode, the thermostat 10 is instructing the HVAC system 14 to operate an air conditioning system to cool the structure 12. Indicator 32 will illuminate while the thermostat 10 is operating in the heating mode. In the heating mode, the thermostat 10 is instructing the HVAC system 14 to run a heating system (e.g., furnace) to heat the structure 12. Finally, the indicator 30 will illuminate while the thermostat 10 is operating in the fan only mode. In the fan only mode, the thermostat 10 is instructing the HVAC system 14 to circulate air through the structure 12 using a fan within the HVAC system regardless of heating or cooling operation. Depending on the particular application, the indicator 30 may illuminate whenever the fan is running or may illuminate only when the fan is selected to run continuously.

In embodiments of the present invention that do not utilize automated switching control between the heating and cooling modes of operation, the indicators 28, 30 and 32 may operate as user selectable switches to allow the consumer to select the operating mode of the thermostat 10. For example, during the summer months the consumer may select the cooling mode by depressing indicator 28. In this mode, the furnace will not be turned on even if the interior ambient temperature drops below the set point. To switch from the cooling to the heating mode of operation, the consumer, in this alternate embodiment, would need to select indicator 32 to allow the thermostat 10 to operate the furnace. Consumer selection in this embodiment of indicator 30 would operate the fan continuously, as opposed to its normal automatic operation based upon a call for cooling or heat by the thermostat 10. In a still further embodiment of the present invention, the indicators 28, 30, 32 may also be utilized to provide a visual indication of system trouble, or that there is a system reminder message being displayed on the display 18.

The internal temperature sensor 34 is employed to sense an ambient temperature within the structure 12 proximate the sensor. Based on the temperature sensed by the internal temperature sensor 34, the thermostat 10 is able to instruct the HVAC system 14 to ensure the comfort of an occupant and/or to promote energy efficiency. Referring back to FIG. 1, the thermostat 10 can also be operably coupled to, and in communication with, a remote temperature sensor 40. The remote temperature sensor 40 is remotely located relative to the internal temperature sensor 34 in the thermostat 10 and provides an indication of the temperature at a different location within the structure 12. Using one or more remote temperature sensors 40, the thermostat 10 is able to more precisely control temperatures within the structure 12.

The microphone 36 is a transducer (e.g., sensor) that converts sound into an electrical signal. When a sound or pattern of sounds is sensed by the microphone 36, the microphone generates or produces a particular electrical signal that corresponds to the sensed sound. In other words, the electrical signal directly correlates to the sound sensed by the microphone 36. Because of the relationship between sensed sound and the electrical signal, sounds can be distinguished and/or differentiated from other sounds by examining the electrical signal produced by the microphone 36 in response to the sound.

The microphone 36 can be one of several varieties or different types of microphones depending on the particular application (e.g., the type of structure 12 where the thermostat 10 is employed, the environment within the structure, etc.). For example, the microphone 36 can be a capacitor microphone, a condenser microphone, an electret (polarized) microphone, a dynamic microphone, a carbon microphone, a piezo microphone, and the like.

The electronic circuit 38 is generally a device such as, for example, a microprocessor, microcontroller, programmable logic device, and the like. The electronic circuit 38 preferably employs software and/or firmware to control operation of the HVAC system. It also includes pattern recognition programming that allows the thermostat to recognize and differentiate the audible signals based on the pattern of electrical signals generated by the microphone 36. In the present application, because the electronic circuit 38 is operably coupled to the microphone 36, the electronic circuit is able to interpret and/or analyze the electrical signal relating to the sound or pattern of sounds detected by the microphone 36.

In one embodiment, the electronic circuit 38 operates in conjunction with a filter circuit 42 and an amplification circuit 44 disposed within the thermostat 10. The filter circuit 42 and the amplification circuit 44 are able to filter, amplify, and otherwise process the electrical signal generated by the microphone 36. The electronic circuit 18 can also include a variety of hardware components and peripheral devices such as, for example, a memory.

Referring back to FIG. 1, in addition to the thermostat 10, the structure 12 includes one or more hazardous condition detectors 46. The hazardous condition detectors 46 are each transducers (e.g., sensors) able to sense a dangerous condition and/or a hazardous substance within the structure 12. Some of the more common and/or well known hazardous condition detectors 46 are, for example, smoke detectors, carbon monoxide detectors, radon detectors, and the like. In one embodiment, the hazardous condition detectors 46 are configured to sense more than one hazardous condition or substance within the structure 12. In other words, the hazardous condition detectors 46 can be multifunctional.

Still referring to FIG. 1, the hazardous condition detectors 46 are variously located within the structure 12. In particular, at least one of the hazardous condition detectors 46 is located on each of the first and second floors 48, 50 as well as in the basement 52. In addition, one of the hazardous condition detectors 46 is also located in almost every area or room in the structure 12. For example, the hazardous condition detectors 46 are found in a bathroom 54, a bedroom 56, a kitchen 58, a living room 60, and a den or basement television room 62. The placement of the hazardous condition detectors is not arbitrary. In fact, many modern building codes, for example, require that the hazardous condition detectors 46 be dispersed throughout the structure 12 and near or within certain rooms such as sleeping quarters.

Despite being physically separated from each other, each of the hazardous condition detectors 46 is preferably in communication with the other hazardous condition detectors. Such communication can be via wires strung or fed through the structure 12 or can be through wireless communication. As such, if one of the hazardous condition detectors 46 observes a hazardous condition, that hazardous condition sensor can relay that fact to the other sensors and a collective warning signal can be generated throughout the structure 12.

The warning signal generated by the hazardous condition detectors 46 upon detection of a hazardous condition or substance within or proximate the structure 12 can be visual, audible, or both. In any case, the warning signal is designed to alert residents, guests, or other occupants within and around the structure 12 regarding the hazardous condition.

Pursuant to industry standards set by certain groups, at least the audible portion of the alarm warning signal generated by the hazardous condition detectors 46 is unique for each particular condition and/or dangerous substance detected. In at least one embodiment, the audible portion of the alarm warning signal comprises a “horn pattern” that has been developed and/or mandated by Underwriters Laboratories, Inc. Each hazardous condition warrants its own distinctive sound or pattern of sounds such that the residents, guests, or other occupants within and around the structure 12 are, in theory, able to quickly discern the particular hazardous condition present and take immediate action armed with that knowledge.

To prevent the HVAC system from making the hazardous condition worse, the thermostat 10 is programmed to allow it to notify occupants regarding the hazardous condition detected in the structure 12 as well as take steps to mitigate and/or eliminate that hazardous condition as will be more fully explained below.

In operation, when one of the audible warning signals (e.g., pattern of chirps, beeps, etc.) is detected, the microphone 36 generates an electrical signal or other output corresponding to that particular audible signal. For example, if one of the hazardous condition detectors 46 detects smoke in the structure 12, the hazardous condition detector generates an audible warning signal specific to the detection of smoke. The microphone 36 in the thermostat 10 senses this specific audible warning signal and generates a corresponding electrical signal. In turn, the electronic circuit 38 analyzes or interprets the electrical signal and makes the determination that the electrical signal has indicated smoke. Based upon this determination, the electronic circuit 38 instructs the HVAC system 14 to deactivate or shut down so as to not spread smoke throughout the structure 12. That is, the HVAC system 14 discontinues cooling, heating, or simply circulating air within the structure 12. As a result, a fire within the structure causing the smoke is not fed fresh air and smoke is not circulated throughout the structure 12.

As a further example, if one of the hazardous condition detectors 46 detects an elevated level of carbon monoxide in the structure 12, the hazardous condition detector generates an audible warning signal specific to the detection of a dangerous level of the carbon monoxide. The microphone 36 in the thermostat 10 senses this specific audible warning signal and generates a corresponding electrical signal. In turn, the electronic circuit 38 analyzes or interprets the electrical signal and makes the determination that the electrical signal has indicated a hazardous level of carbon monoxide. Based upon this determination, the electronic circuit 38 instructs the HVAC system 14 to activate or turn on its fan or blower, and to deactivate or turn off the furnace as the burner may be the source of CO. As such, the HVAC system 14 begins circulating air within the structure 12 to dissipate the concentration of CO and/or introduce fresh air.

In addition to the above examples, the electronic circuit 38 of the thermostat 10 can recognize a variety of different electrical signals based upon the occurrence of several different hazardous conditions that might occur and be detected within the structure 12. Based on any of these sensed conditions, the thermostat 10 (or the electronic circuit 38 therein) instructs the HVAC system 14 appropriately to mitigate and/or reduce the hazardous condition.

In one embodiment the thermostat produces a visual warning message on the display 18 in response to the warning signal detected by the microphone 36 of the thermostat 10. Such a visual warning can also or alternatively be generated using the operating mode visual indicators 28, 30, 32. As such, a visual portion of the warning signal can take the form of text, flashing lights, illuminated icons, instructions and combinations thereof.

From the foregoing, those skilled in the art will recognize that embodiments of the invention provide a thermostat able to sense an audible warning signal generated by one or more hazardous condition sensors upon the occurrence of a hazardous condition and, based on the sensed warning signal, instruct the HVAC accordingly. Further, the invention is an improvement over existing thermostats because it provides wireless connectivity between existing hazardous condition detectors (i.e., threat detectors) and the thermostat, even for older detectors that do not include any type of wireless radio frequency (RF) transmitter. Previous and existing hazardous condition detection systems are almost all autonomous and, consequently, the HVAC system does not respond appropriately or well to hazardous situations. In contrast, a thermostat (e.g., thermostat 10) with audible interconnect capability is able to “listen” to standard thread detectors and control the HVAC system in response thereto.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat for controlling a heating, ventilating and air conditioning (HVAC) system based an audible warning signal, the thermostat comprising:
a microphone for sensing the audible warning signal, the microphone generating an electrical signal corresponding to the audible warning signal; and
an electronic circuit operably coupled to the microphone, the electronic circuit controlling the HVAC system to mitigate an impact of the hazardous condition in response to the electrical signal.

2. The thermostat of claim 1, wherein the microphone is one of a capacitor microphone, a condenser microphone, an electret (polarized) microphone, a dynamic microphone, a carbon microphone, and a piezo microphone.

3. The thermostat of claim 1, wherein the thermostat further comprises at least one of a filter circuit and an amplification circuit operably coupled between the microphone and the electronic circuit.

4. The thermostat of claim 1, wherein the thermostat further comprises a visual warning device, and wherein the electronic circuit controls the visual warning device to provide a visual warning when the audible warning is sensed.

5. The thermostat of claim 4, wherein the visual warning device is a light emitting diode (LED) and wherein the electronic circuit illuminates the LED to provide the visual warning.

6. The thermostat of claim 5, wherein the visual warning device is a liquid crystal display (LCD), and wherein the electronic circuit generates a textual message on the LCD to provide the visual warning.

7. The thermostat of claim 1, wherein the electronic circuit determines a type of detected hazardous condition based on the electrical signal.

8. The thermostat of claim 7, wherein the type of detected hazardous condition is fire, and wherein the electronic circuit disables operation of a blower of the HVAC system.

9. The thermostat of claim 8, wherein the electronic circuit disables operation of a furnace and an air conditioning (A/C) unit.

10. The thermostat of claim 7, wherein the type of detected hazardous condition is carbon monoxide (CO), and wherein the electronic circuit turns on a blower of the HVAC system.

11. The thermostat of claim 10, wherein the electronic circuit disables operation of a furnace.

12. The thermostat of claim 1, wherein the electronic circuit disables operation of a furnace.

13. A system for a structure employing a heating, ventilating and air conditioning (HVAC) system, the system comprising:
at least one hazardous condition detector, the at least one hazardous condition detector generating an audible warning signal upon the occurrence of a hazardous condition; and
a thermostat having a microphone for sensing the audible warning signal, the microphone generating an electrical signal corresponding to the audible warning signal, and an electronic circuit operably coupled to the microphone, the electronic circuit controlling the HVAC system to mitigate an impact of the hazardous condition in response to the electrical signal.

14. The system of claim 13, wherein the electronic circuit determines a type of detected hazardous condition based on the electrical signal.

15. The system of claim 14, wherein the hazardous condition detector is a smoke detector, and wherein the electronic circuit disables operation of a blower of the HVAC system in response the audible warning signal.

16. The system of claim 15, wherein the electronic circuit disables operation of a furnace and an air conditioning (A/C) unit in response the audible warning signal.

17. The system of claim 14, wherein the hazardous condition detector is a carbon monoxide (CO) detector, and wherein the electronic circuit turns on a blower of the HVAC system in response to the audible warning signal.

18. The thermostat of claim 17, wherein the electronic circuit disables operation of a furnace in response to the audible warning signal.

19. The thermostat of claim 13, wherein the electronic circuit disables operation of a furnace in response to the audible warning signal.

20. A method of controlling a heating, ventilating and air conditioning (HVAC) system during a detected hazardous condition, comprising the steps of:
sensing by a microphone in a thermostat an audible warning signal generated by a hazardous condition detector;
controlling operation of the HVAC system in response to the step of sensing.

21. The method of claim 20, wherein the step of controlling comprises the step of disabling a furnace of the HVAC system.

22. The method of claim 20, further comprising the step of determining by the thermostat a type of detected hazardous condition from the audible warning signal.

23. The method of claim 22, wherein the step of determining determines that the type of detected hazardous condition is a fire, and wherein the step of controlling comprises the step of disabling operation of a blower of the HVAC system.

24. The method of claim 22, wherein the step of determining determines that the type of detected hazardous condition is carbon monoxide, and wherein the step of controlling comprises the step of turning on a blower of the HVAC system.

25. The method of claim 20, further comprising the step of displaying on the thermostat a visual warning in response to the step of sensing.
